(19) United States
(12) Patent Application Publication
(10) Pub. No.: US 2018/0178402 A1
(43) Pub. Date: Jun. 28, 2018

(54) APPARATUS AND METHOD FOR NOTCH PREPARATION IN POLYMERIC FILM AND SHEET

(71) Applicant: Sabic Global Technologies, B.V., Bergen op Zoom (NL)

(72) Inventors: Devendra Bajaj, Evansville, IN (US); Stephen L. Gardner, Evansville, IN (US)

(21) Appl. No.: 15/848,168

(22) Filed: Dec. 20, 2017

Related U.S. Application Data
(60) Provisional application No. 62/438,116, filed on Dec. 22, 2016.

(51) Int. Cl. B26D 3/08; G01N 1/28

(52) U.S. Cl. CPC B26D 3/085; G01N 2001/2873; G01N 1/286

(57) ABSTRACT

An apparatus for preparing notches in material samples for fracture mechanics testing is disclosed. The apparatus includes a base and a sample holder for gripping a sample. A linear rail is inclined at an angle relative to the sample holder, and may be attached to an attachment column extending upward from the base. A carriage assembly attached to the linear rail includes: a carriage capable of sliding up and down along the linear rail and a blade holder attached to the carriage. The blade holder slides up and down the linear rail to initiate a notch in the sample.

### CROSS-REFERENCE TO RELATED APPLICATION

This application claims the benefit of U.S. Provisional Patent Application Ser. No. 62/438,116 filed Dec. 22, 2016. The related application is incorporated herein in its entirety by reference.

### BACKGROUND

The present disclosure relates to apparatuses and methods for fracture mechanics testing. In particular, the apparatuses and devices described herein are used for preparing sharp notches in polymeric films and sheets having a thickness of less than about 1 millimeter (mm) for fracture toughness characterization, and will be described with particular reference thereto. The apparatuses have design features intended to increase repeatability and reproducibility of testing conditions.

Fracture mechanics is used to study the initiation and propagation of cracks in materials. In particular, fracture toughness is a quantitative way of expressing a material's resistance to fracture when a crack is present. For thin film materials, fracture toughness characterization can be difficult due to thickness limitations which do not generally affect thicker bulk materials. By initiating a crack from a sharp notch in a thin film material sample, the material's inherent resistance to crack growth can be calculated. Thus, fracture toughness characterization requires initiation of a sharp notch in the test sample.

A double edge notched tensile (DENT) specimen, which consists of two notches one each on the long edges of the specimen, is commonly used in fracture toughness characterization of polymeric films and sheets using the work of fracture approach [J. Wu and W. Y. Mai, The essential fracture work concept for toughness measurement of ductile polymers. Polymer Engineering and Science, Volume 36, Issue 18, September 1996, Pages 2275-2288]. Notch initiation in thin film material samples is traditionally achieved by manually pushing a blade into the specimen. However, these existing methods make it difficult to achieve repeatability and reproducibility in preparing the notches in DENT specimens, resulting in variation in the measured toughness.

It would be desirable to provide a notching apparatus that allow preparation of sharp, straight and aligned notches to improve the consistency of fracture characterization in thin film material specimens.

### BRIEF SUMMARY

The present disclosure relates to apparatuses and methods for preparing notches in polymeric films and sheets, including both amorphous and semi-crystalline materials. These apparatuses can also be referred to herein as an “apparatus”. Generally, the apparatus includes a base having a top surface and a sample holder mounted on the top surface for gripping a sample. A linear rail is also present, which is inclined at an angle relative to the sample holder. A carriage assembly is attached to the linear rail, the carriage assembly including a carriage and a blade holder. To make a notch, the carriage assembly slides down the linear rail, and a blade makes a notch in the material sample that is held by the sample holder.

Disclosed in several embodiments herein are apparatuses for making notches, comprising: (a) a base having a top surface; (b) a sample holder mounted upon the top surface for placing an associated sample; (c) a linear rail that is mounted upon the top surface and inclined at an angle relative to the sample holder; (d) a carriage assembly attached to the linear rail, the carriage assembly including: (i) a carriage capable of sliding along the linear rail; and (ii) a blade holder attached to the carriage. While the apparatus is generally illustrated herein as comprising a carriage that is capable of sliding along the linear rail, it is also envisioned that the carriage could be stationary and the sample holder could be capable of sliding along the linear rail. Such a configuration might have a safety benefit in that the blade would be stationary. Likewise, it is also envisioned that both the carriage and the sample holder could be capable of sliding relative to each other. Accordingly, various embodiments are envisioned wherein the relative position between the carriage and the sample holder can be controlled.

The sample holder may be mounted upon the top surface through at least one positioning pin (usually two are present). The sample holder may comprise an upper platen and a lower platen, the associated sample being placed between the upper and lower platens. The upper and lower platens may each include at least one vertical slot in a middle portion thereof (usually two vertical slots are present).

The linear rail may be connected to an attachment column that is mounted on the top surface. The apparatus may further comprise a safety guard placed so that the carriage assembly travels along a path between the linear rail and the safety guard. In particular embodiments, the safety guard is also connected to the attachment column.

The carriage assembly may further comprise (iii) a handle extending out from a first side of the carriage for manually sliding the carriage along the linear rail.

The apparatus may further comprise a locking pin that is moveable between (i) a locked position for holding the carriage assembly at a specified height and (ii) an unlocked position for allowing the carriage assembly to move along the linear rail. The locking pin may be spring loaded.

The apparatus may further comprise a stopper mounted on the top surface of the base to stop the sliding motion of the carriage assembly. The blade holder may be a spring loaded clamp.

In particular embodiments, the apparatus further comprises: (e) an attachment column mounted on the top surface of the base, wherein the linear rail is connected to the attachment column; (f) a safety guard placed so that the carriage assembly travels along a path between the linear rail and the safety guard, wherein the safety guard is connected to the attachment column; and (g) a locking pin that is moveable between (i) a locked position for holding the carriage assembly at a specified height and (ii) an unlocked position for allowing the carriage assembly to move along the linear rail, wherein the locking pin is connected to the attachment column and engages a second side of the carriage; and wherein the carriage assembly further comprises (iii) a handle extending out from a first side of the carriage for manually sliding the carriage along the linear rail.

Also disclosed herein are methods for making a notch in a material sample, comprising: receiving an apparatus for making notches that comprises: (a) a base having a top surface; (b) a sample holder mounted upon the top surface for placing the material sample; (c) a linear rail that is mounted upon the top surface and inclined at an angle relative to the sample holder; (d) a carriage assembly attached to the linear rail, the carriage assembly including: (i) a carriage capable of sliding along the linear rail; and (ii) a blade holder attached to the carriage; securing the material sample in the sample holder; mounting a blade in the blade holder; and making a notch in the material sample by sliding the carriage assembly down the linear rail to push the blade through the material sample.

A stopper may be used to control a depth of the notch.

In some embodiments, the method further comprises retracting the carriage assembly up the linear rail until a locking pin locks the carriage assembly above a specified height.

Additional embodiments further comprise: rotating the sample holder 180 degrees and remounting the sample holder to the top surface of the base; and making a second notch in the material sample by sliding the carriage assembly down the linear rail to push the blade through the material sample.

The carriage assembly can be slid down the linear rail using a handle extending out from a first side of the carriage. Alternatively, the carriage assembly can be motorized.

The material sample may be generally made from any amorphous or semi-crystalline material, such as a thermoplastic polymer, or a polycarbonate film or sheet. Work of fracture toughness test results obtained from polycarbonate samples made according to the methods disclosed herein may have a standard deviation of about 3.0 kilojoules per meter squared (kJ/m²) or lower. A regression analysis on work of fracture toughness test results obtained from samples made according to the methods disclosed herein may have an R² of at least 0.80. These values may change depending on the material.

These and other non-limiting aspects and/or objects of the disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a perspective view schematic of a film and sheet notching apparatus according to one embodiment of the present disclosure.

FIG. 2 is a side view schematic of the notching apparatus of FIG. 1.

FIG. 3 is a perspective picture of a film and sheet notching apparatus according to a second embodiment of the present disclosure.

FIG. 4 is a graph of the results of the work of fracture as a function of ligament length for DENT specimens produced by conventional methods versus methods according to an embodiment of the present disclosure.

FIG. 5A is a schematic showing a double edge notched tensile DENT specimen used in fracture toughness characterization for thin films and sheets.

FIG. 5B a representative load versus displacement curves for DENT specimens used in fracture toughness characterization with four different ligament lengths. As labeled here, l₁ is the bottom curve, l₂ is the next lowest curve, l₃ is the next lowest curve, and l₄ is the top curve.

FIG. 5C is a representative specific total work of fracture (W_{f}) versus length (l) curve used to calculate the specific essential work of fracture (fracture toughness, wₑ) for DENT specimens. The y-intercept is wₑ, and the slope is βwₚ.

FIG. 5D is a schematic showing a double edge notched tensile DENT specimen used in fracture toughness characterization for thin films and sheets according to one embodiment of the present disclosure.

FIG. 6A is a top view of an existing notch forming method.

FIG. 6B is a side view of the existing notch forming method illustrated in FIG. 6A.

FIG. 7 is an optical microscopy image of the notch tip regions in a double edge notched tensile (DENT) specimen created using conventional methods showing an offset in the alignment of the two notches.

FIG. 8 is an optical microscopy image of the notch tip regions in a DENT specimen created using conventional methods showing deflection of the two notches.

### DETAILED DESCRIPTION

A more complete understanding of the devices and methods disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function. In the following specification and the claims which follow, reference will be made to a number of terms, which shall be defined to have the following meanings.

The singular forms “a,” “an,” and “the” include plural referents unless the context clearly dictates otherwise. The term “or” means “and/or” unless clearly indicated otherwise by context.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing devices or methods as “consisting of” and “consisting essentially of” the enumerated components/steps, which allows the presence of only the named components/steps, and excludes other components/steps.

Numerical values in the specification and claims of this application should be understood to include (i) numerical values which are the same when reduced to the same number of significant figures and (ii) numerical values which differ from the stated value by less than the experimental error of conventional measurement technique of the type described in the present application to determine the value.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

Some terms used herein are relative terms. For example, the terms “upper” and “lower” are relative to each other in location, i.e. an upper component is located at a higher elevation than a lower component along a vertical axis. The upper end of a first component and the upper end of a second component are both oriented in the same direction on the axis, as are their lower ends.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other. The terms “upwards” and “downwards” are also relative to an absolute reference; an upwards flow is always against the gravity of the earth.

The present disclosure relates to a sample preparation device for preparing fracture mechanics notches in polymeric films and sheets. Generally, the preparation device includes a sample holder, in which an un-notched material sample is placed. The sample holder includes at least one vertical slot. A linear rail includes a carriage assembly that holds a blade. The sample preparation device can comprise one or more linear rails. Specifically, the sample preparation device comprises one linear rail. The linear rail is inclined at an angle relative to the sample holder. The carriage assembly is slid down the linear rail, and the blade travels through the vertical slot to make a notch in the material sample.

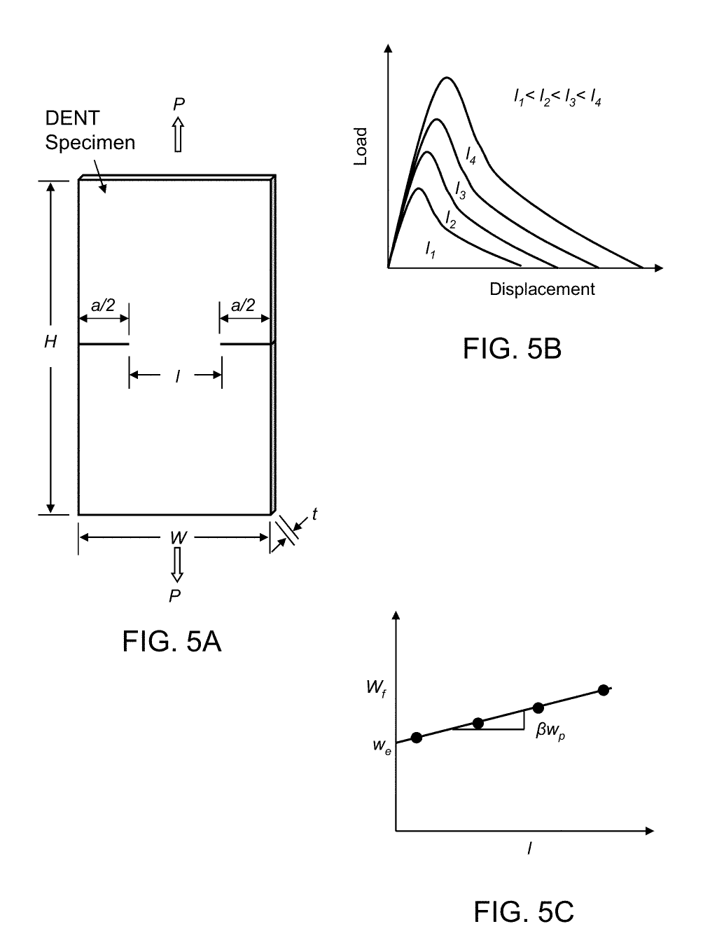

The fracture toughness of polymeric films and sheets is typically determined via the work of fracture approach [J. Wu and W. Y. Mai, The essential fracture work concept for toughness measurement of ductile polymers. Polymer Engineering and Science, Volume 36, Issue 18, September 1996, Pages 2275-2288]. In the work of fracture method, single edge trouser tear specimens or double edge notched tension (DENT) specimens with different ligament lengths (l) are loaded to failure under tension. A typical DENT specimen is illustrated in FIG. 5A. The DENT specimen in FIG. 5A has a thickness t, height H, and width W. The DENT specimen has two notches of length a/2 that are opposite to each other. The uncut width l, is the ligament that undergoes deformation when the DENT specimen is loaded under tension (P). As will be appreciated by those skilled in the art, the DENT test specimen can be made of any suitable material where it is desired to measure fracture toughness. As will also be appreciated, the test specimen can be made in any desired dimension from any suitable method. For example, the DENT test specimen can be made from a polymeric material such as transparent polycarbonate film or sheet, such as LEXAN® 8010, and can be cut from the film or sheet using any suitable tool, such as a tile cutter. Alternatively, the DENT specimen can be cut from the film or sheet using a wire cut die with one or multiple cavities. An example of a DENT specimen cut using a single cavity wire cut die is illustrated in FIG. 5D. Similar to the DENT specimen illustrated in FIG. 5A, the specimen illustrated in FIG. 5D has a ligament length l, height H, width W, notch lengths a/2, and is loaded under tension (P); however, the notches in the specimen of FIG. 5D have a different shape which is achievable with a wire cut die. The geometry of the DENT test sample should permit the gripping of the sample by a suitable sample holder. In particular embodiments, the DENT test sample can have a thickness of about 1 mm or less, a width of about 35 mm and a length of about 100 mm. In addition, the DENT test sample can be prepared at a variety of suitable ligament lengths. In particular embodiments, the DENT test sample has a ligament length of about 1 mm to about 20 mm. In embodiments corresponding to the DENT specimen illustrated in FIG. 5D, the notches generally have a parabolic shape, and the round portion of the parabola-shaped notch can have a radius (r) of about 0.1 mm to about 1 mm, including about 0.5 mm. In addition, the notch can have a notch width N_{w} of about 5 mm to about 15 mm, including about 10 mm, extending over an angle Q of about 0° to about 100°, including about 65°.

The resulting load versus displacement curve for each specimen is used to determine the total work of fracture (W_{f}), i.e., the area under the load versus displacement curve shown in FIG. 5B. In particular, FIG. 5B illustrates representative load versus displacement curves for DENT specimens with different ligament lengths (l₁, l₂, l₃, l₄), where l₁<l₂<l₃<l₄. The work of fracture W_{f} is comprised of two parts, i.e., essential (wₑ, the work required to create new surface in the specimen's process zone) and non-essential work of fracture (wₚ, associated with the work done by various deformation mechanisms in the plastic zone and volume-related). The work of fracture W_{f} can be expressed as:

W_{f}=Wₑ+Wₚ (1)

W_{f}=wₑtl+wₚβtl² (2)

w_{f}=W_{f}/tl=wₑ+wₚβl (3)

where t is film thickness, w_{f} is specific work of fracture, wₑ is specific essential work of fracture and wₚβ is specific non-essential work of fracture. As shown in FIG. 5C, the intercept of the linear fit in to the y-axis in Equation (3) provides the fracture toughness, also known as the specific essential work of fracture (wₑ). In particular, the curve of the specific total work of fracture (w_{f}) versus ligament length (l) shown in FIG. 5C is used to calculate the specific essential work of fracture (fracture toughness, wₑ).

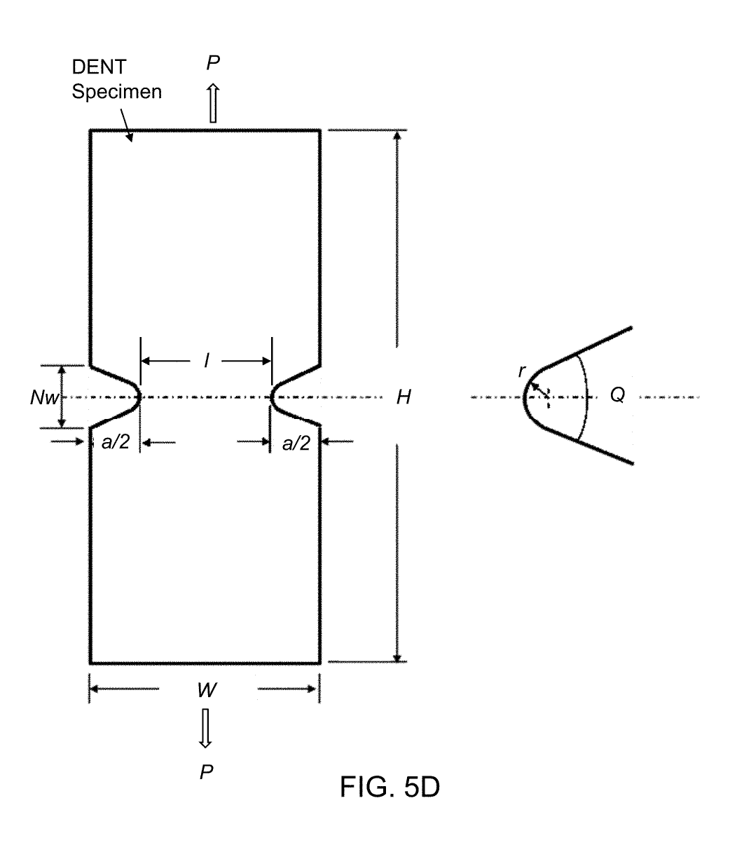

A double edge notched tensile (DENT) specimen is typically prepared by cutting a rectangular test coupon from a sheet or plaque of polymeric material. The specimen is subsequently notched by pushing a fresh steel blade through the specimen. FIG. 6A is a top view of an existing notch forming method, and FIG. 6B is a side view of the existing method. As illustrated here, a linear low density polyethylene (LLDPE) specimen is laid upon a glass substrate. Two slots are present on opposite sides of the glass substrate, labeled here as A and A′. To control the path of the blade and insure that the two notches are straight and aligned, a metal template is placed upon the specimen and is used to guide the blade thought the slot to form a notch on both sides of the specimen.

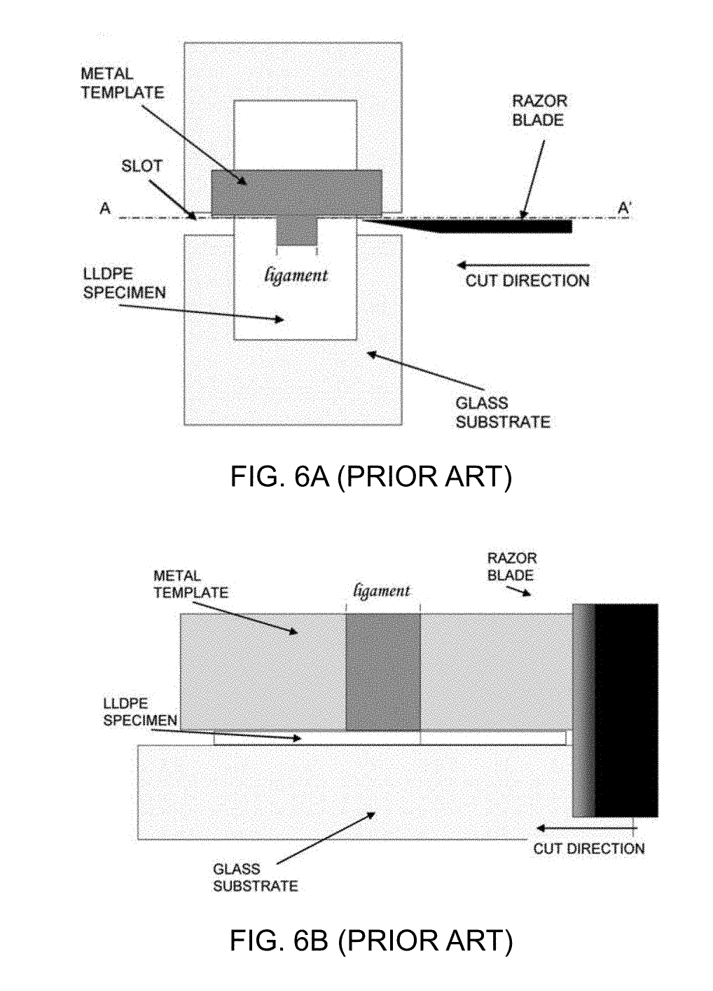

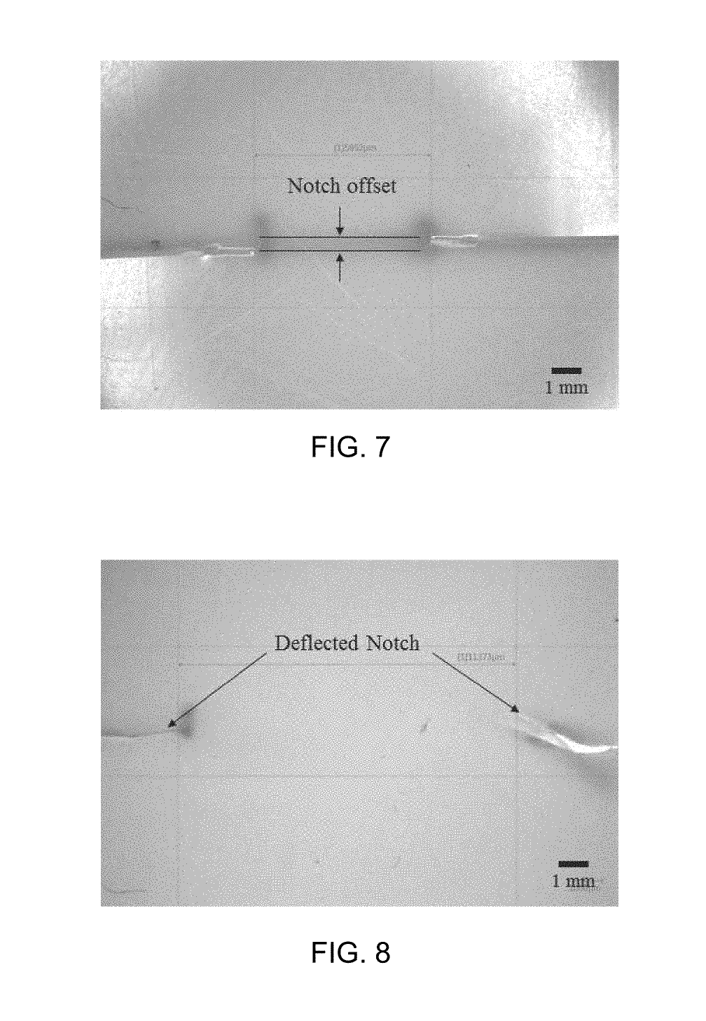

This existing method is performed manually, which makes it difficult to achieve repeatability and reproducibility in preparing the notches in multiple DENT specimens, resulting in variation in the measured toughness of identical materials. Existing techniques can also result in significant variation in the length, sharpness, uniformity and alignment of the two notches in the same specimen. Typical examples of defects in notches prepared using the existing methods are shown in FIG. 7 and FIG. 8, which show DENT specimens prepared from a LEXAN® 8010 sheet. FIG. 7 shows an off-set in the alignment of the two notches, i.e. the notches are not parallel to each other. FIG. 8 shows deflection of the notches, where the notches are not straight. Such non-uniformity and misalignment of notches can result in significant variation in the specific energy to fracture. These optical microscopy images, along with significant scatter in the work of fracture data, illustrate the limited control over the alignment and uniformity of the notches created using existing methods.

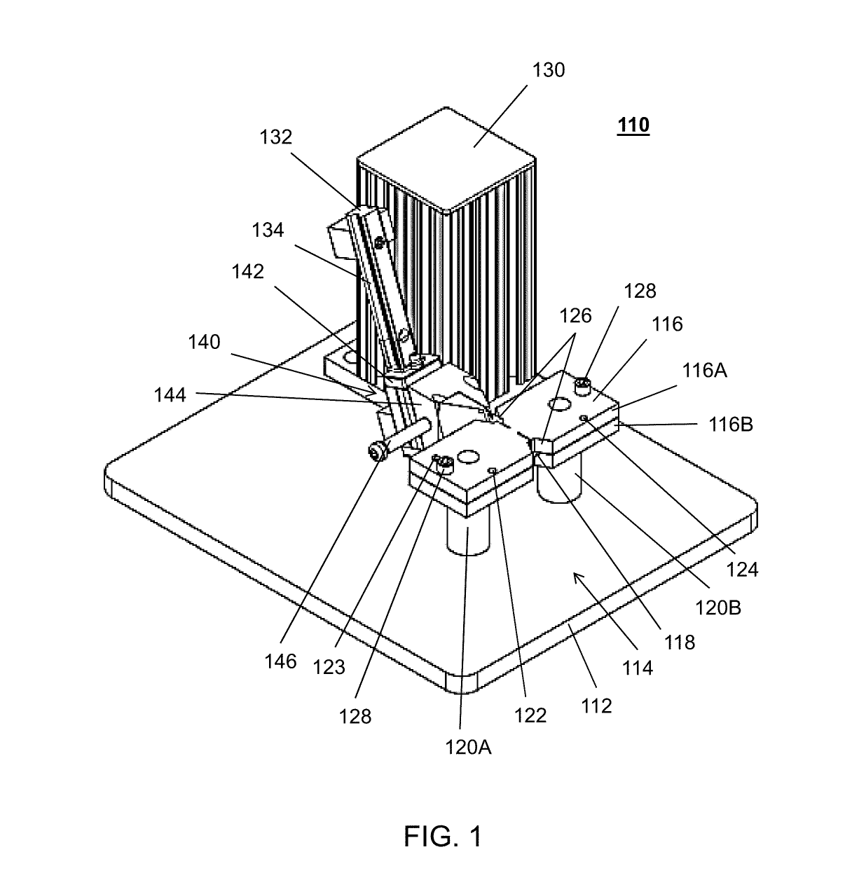

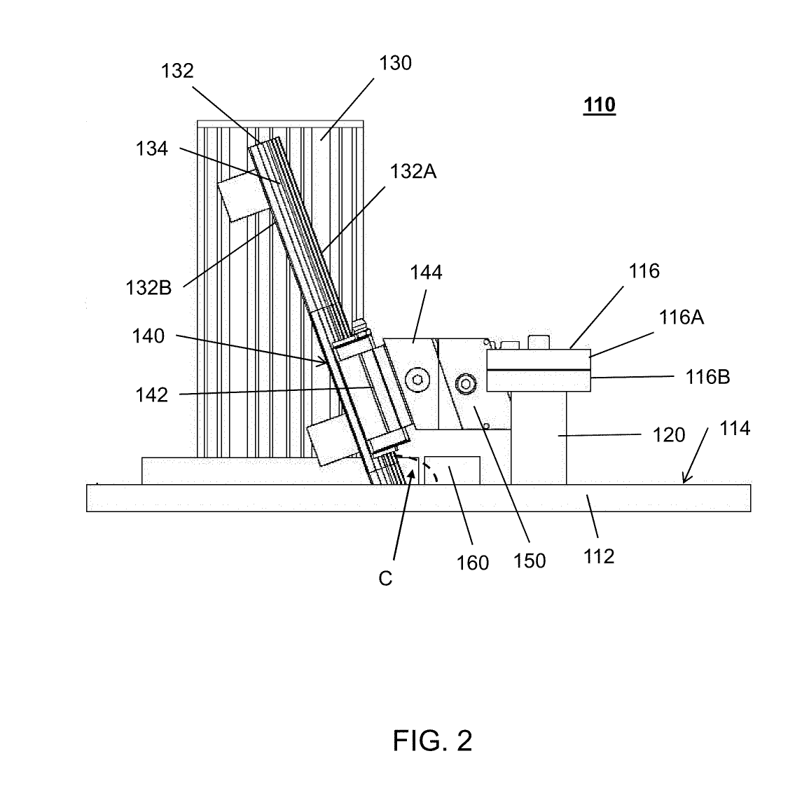

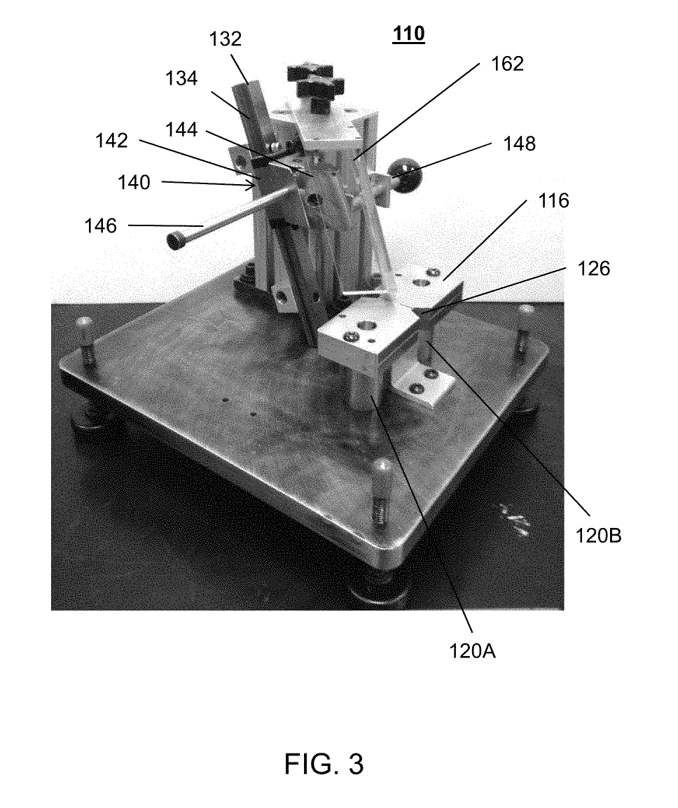

FIGS. 1-3 are different views of exemplary film and sheet notch preparation apparatuses of the present disclosure. FIG. 1 is a perspective view of a first exemplary embodiment of the notch-making apparatus. FIG. 2 is a side view of the notch-making apparatus of FIG. 1. FIG. 3 is a photograph of a second exemplary embodiment of a notch-making apparatus.

Referring first to FIG. 1 and FIG. 2, the apparatus 110 is used to prepare fracture mechanics notches in polymeric film and sheet, such as material sample or specimen 118. The apparatus 110 includes a base 112, which has a top surface 114 defining an x-y plane.

A sample holder 116 is mounted upon the top surface 114 of the base 112 via at least one positioning pin. As seen here, two positioning pins 120A and 120B project upwardly from the top surface 114 of the base 112, holding the sample holder 116 and sample 118 at a desired height for notch formation. While illustrated here as being of a cylindrical shape, it is contemplated that the positioning pin could be shaped so that only one such positioning pin is needed.

The sample holder 116 operates to securely grip the test sample 118 such that the specimen does not shift in position or become dislodged during notch formation. The sample holder 116 depicted here includes two metal platens, upper platen 116A and lower platen 116B, with the sample 118 being placed between the upper and lower platens. The platens 116A and 116B can be tightened together in order to secure the sample 118 within the holder 116 via one or more fasteners 128 that join the two platens together, shown here as threaded screws. In some embodiments, the platens can be made from aluminum. Guide pins 122, 123, and 124 can extend through the upper and lower platens 116A and 116B to properly position the sample 118 within the sample holder 116. The platens 116A and 116B also have vertical slots or openings 126 formed along the long edges thereof and located in the middle portion of both sides of the platens. The openings 126 act as a blade guide for directing a blade 150 into the sample 118. The blade can be any cutting device suitable to make a notch, for example, a razor or other type of blade.

The apparatus 110 also includes a linear rail 132 that is mounted upon the top surface 114 of the base 112. The linear rail is inclined at an angle C (dashed line in FIG. 2) relative to the sample holder 116, with the sample holder being parallel to the base 112. As seen here, the angle C is an obtuse angle as measured from the top surface 114 of the base 112 to a front surface 132A of the linear rail 132, i.e. between the linear rail 132 and the sample holder 116. As will be appreciated by those skilled in the art, the incline of the linear rail 132 can be defined as an acute angle if measured from the top surface 114 of the base 112 to a rear surface 132B of the linear rail 132 which is opposite to front surface 132A. The linear rail 132 is illustrated in FIGS. 1-3 as being fixed at an angle of approximately 110°. However, in other embodiments, the linear rail 132 is not fixed and is adjustable to be inclined at any value between about 95° and about 175°. The linear rail also includes a track 134 along which a carriage assembly 140 travels up and down along the linear rail.

As illustrated here, an attachment column 130 is mounted on the top surface 114, and extends upward from the top surface 114 of the base 112. The linear rail 132 is directly mounted to the attachment column 130. The attachment column is depicted here with a rectangular shape, but may have any appropriate shape.

The carriage assembly 140 includes a carriage 142 which is attached to the linear rail 132 of the attachment column 130. The carriage 142 is located between the linear track 132 and the sample holder 116. The carriage 142 can slide up and down the linear rail along the track 134, for example via ball bearings (not shown) that interact with the linear rail 142. The bearings can be any suitable bearing known to those in the art, such as, for example ball bearings, dovetail bearings, linear roller bearings, magnetic or fluid bearings, etc. The carriage assembly 140 also includes a blade holder 144 attached to the carriage 142. The blade holder 144 is used to hold a blade 150 with the sharp end protruding outward towards the sample holder 116. The blade holder 144 can be a spring loaded clamp. As illustrated here, a handle 146 extends outward from a first side of the carriage assembly 140, such as from the carriage 142 or blade holder 144. The handle 146 can be used to manually slide the entire carriage assembly 140 up and down along the linear rail 142. Alternatively, the carriage assembly 140 can be motorized (not shown) for automated movement up and down the linear rail 142. In that case, a handle may not be needed.

As seen in FIG. 2, a stopper 160 is also mounted on the top surface 114 of the base 112 to stop the sliding motion of the carriage assembly 140. The stopper 160 is generally positioned under the blade holder 144. Described another way, the stopper is located upon the top surface 114 between the linear rail 132 and the sample holder 116. Stoppers of different heights can be used to create notches of different lengths. Alternatively, an adjustable stopper can be used which is capable of being raised and lowered to various heights can be used. Generally, a stopper with a greater height will stop the sliding motion of the carriage assembly sooner compared to a stopper of a lesser height, thereby creating a notch having a shorter length in the specimen.

During operation of the apparatus 110, a material sample 118 is first secured between the two platens 116A, 116B. The sample holder 116 is then mounted on the base 112 via positioning pins 120A and 120B. A blade 150 is mounted on the blade holder 144. The carriage assembly 140 with the blade holder 144 then slides down the linear rail 132. Once the blade 150 comes in contact with the material sample 118, the blade is gently pushed into the specimen. This action creates a cut in the material sample 118 and produces a sharp notch in one side of the sample. The depth of the cut/notch is controlled by the distance the blade 150 travels along the linear rail 132. The total distance the blade 150 travels can be controlled by using the stopper 160 attached to the base 112 and positioned under the blade holder 144. The apparatus can include stoppers of different heights or a stopper with an adjustable height in order to control the distance the blade 150 travels along the linear rail 132 and thereby the depth of the cut. The carriage assembly 140 is then retracted along the linear rail 132. The specimen holder 116 is removed from the positioning pins 120A and 120B on the base 112, rotated 180° so that the un-notched side of the material sample now faces the blade holder 144, and is re-mounted on the positioning pins again. The notching operation is then repeated for the other side of the material sample 118 to make a second notch. This procedure results in two notches located on opposite sides of the specimen that are of the same length and are aligned. While it is illustrated that the sample is manually removed and rotated 180°, an embodiment where the sample holder 116 is located on a rotatable mount, for example, along an axis of rotation is also envisioned. In such an embodiment, the sample holder 116 could be locked into a first position for making the first notch and rotated 180° without removing the sample holder to a second position for making the second notch. A locking mechanism can be used to lock the sample holder into place in the first position and in the second position for making the second notch. For example, a locking mechanism can include one or both of a clamp to lock the sample holder into place in both the first position and the second position, and a stopper that can stop the rotation of the sample holder once the sample holder has been rotated to the second position. The sample holder can be rotated 180° in a direction parallel or perpendicular to the top surface of the base.

FIG. 3 is a perspective picture showing a second exemplary embodiment of the apparatus 110, with additional features being visible. These additional features are optional, and are not required to be present in all embodiments of the apparatus.

First, a locking pin 148 can also be included. The locking pin 148 is used to lock the carriage assembly 140 in a position which is generally above the sample holder. Thus, the locking pin 148 has a locked position where the pin extends into the path of the carriage assembly along the linear rail 132. This holds the carriage assembly 140 above a specified height, preventing the blade from moving along the linear rail 132 at an undesired time. The locking pin 148 also has an unlocked position that allows the carriage assembly 140 to move up and down the linear rail 132. The locking pin 148 may be spring loaded so that it is biased towards the locked position. As illustrated here, the locking pin is connected to the attachment column 130, and extends toward a second side of the carriage assembly 140 which is opposite to the first side from which the handle 146 extends.

The apparatus 110 also includes a safety guard 162 which is shown here as being attached to the top of the attachment column 130. The safety guard 162 is placed to define a path between the linear rail 132 and the safety guard through which the blade holder 144 and blade 150 travel when the carriage assembly 140 is released. The safety guard 162 prevents accidental contact with the blade 150 while the apparatus 110 is being used. The safety guard here is removable. The safety guard is angled at the same angle as the linear rail 132.

Certain variations are contemplated for the apparatuses described herein. For example, some embodiments do not include an attachment column 130. The linear rail 132 could be shaped and attached directly to the top surface 114. The safety guard 162, if present, could be attached to the upper platen 116A. As seen in FIG. 3, the linear rail 132, and the safety guard 162, and the locking pin 148 are attached to the attachment column 130. It is also contemplated that in other embodiments, only one or two of these components are attached to the attachment column.

The following examples are provided to illustrate the devices and methods of the present disclosure. The examples are merely illustrative and are not intended to limit the disclosure to the materials, conditions, or process parameters set forth therein.

### EXAMPLES

### Example 1

A total of 55 specimens were cut using a tile cutter from 0.5 mm thick LEXAN® 8010 A4 size sheets (n=4). The sample dimensions were 35 mm×100 mm. Two methods were used to prepare the double edge notch tensile (DENT) specimens.

Method 1: In the first method, 23 DENT specimens were prepared by manually notching the samples by pushing a fresh steel blade in the specimen that was laid on a flat glass substrate. To control the travel of the blade and insure that the two notches are straight and aligned, a metal template was used to guide the blade. Specimens with six different ligament lengths (l) of 7, 9, 11, 13, 15 and 17 mm were prepared. The ligament length was measured using an optical microscope.

Method 2: In the second method, 32 DENT specimens were prepared using the film and sheet apparatus of FIG. 3. Specimens with five different ligament lengths (l) of 8, 11, 13, 15 and 17 mm were prepared. The ligament length was measured using an optical microscope.

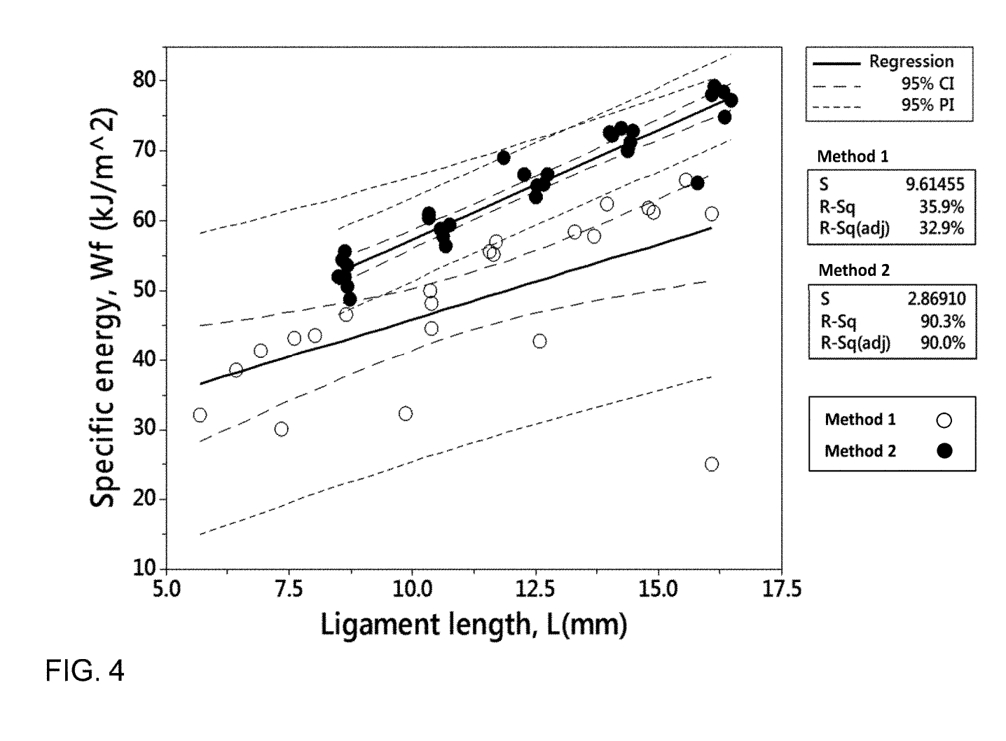

All specimens were then mounted in tensile loading fixtures and tested to failure under displacement control at 12 millimeters per minute (mm/min) (ZWICK universal testing machine). The load versus load-line displacement data was captured throughout the test. The area under the load vs. load-line displacement was calculated to determine the total work of fracture and was divided by the specimen thickness and ligament length to calculate the specific work of fracture (w_{f}) according to Equation (3) above. The specific work of fracture was then plotted against the ligament length (l). The coefficient of the linear fit to the w_{f} versus l curve (illustrated in FIG. 4 as specific energy Wf and ligament length L, respectively) provided the specific essential work of fracture (wₑ, a measure of toughness) and specific non-essential work of fracture (βwₚ).

A comparison of the ligament length produced by Method 1 demonstrated a process variation of 39.6% versus 7.1% variation by Method 2. The results for the work of fracture for each DENT specimen produced by Method 1 and Method 2 were plotted as a function of the ligament length, as shown in FIG. 4. Thus FIG. 4 provides an example of the variability in the work of fracture resulting from the different notch preparation methods, where CI refers to confidence interval and PI refers to predicted interval. A regression analysis on work of fracture data demonstrated a R² of 0.33 for Method 1 and 0.90 for Method 2 (Table 1 below). While the average fracture toughness, wₑ obtained from both methods is comparable, the standard deviation produced by Method 2 (S=2.86 kJ/m2) is more than 3 times smaller than Method 1 (9.61 kJ/m²). In addition, Method 2 gives higher confidence with a R² of 0.90 versus 0.33 for Method 1.

TABLE 1
Results of the Linear Fit to the Work of Fracture
Data Produced on DENT Specimens Prepared Using
Method 1 (Manual) and Method 2 (Instrument)

| Notch preparation method | wₑ (kJ/m²) | βwₚ (kJ/m²/mm) | R² |
|---|---|---|---|
| Method 1 | 24.3 | 2.1 | 0.33 |
| Method 2 | 25.9 | 3.1 | 0.90 |

Set forth below are various embodiments of the present disclosure:

### Embodiment 1

An apparatus for making notches, comprising: (a) a base having a top surface; (b) a sample holder mounted upon the top surface for placing an associated sample; (c) a linear rail that is mounted upon the top surface and inclined at an angle relative to the sample holder; and (d) a carriage assembly attached to the linear rail. The carriage assembly includes (i) a carriage capable of sliding along the linear rail; and (ii) a blade holder attached to the carriage.

### Embodiment 2

The apparatus of embodiment 1, wherein the sample holder is mounted upon the top surface through at least one positioning pin.

### Embodiment 3

The apparatus of any one of the preceding embodiments, wherein the sample holder comprises an upper platen and a lower platen, the associated sample being placed between the upper and lower platens.

### Embodiment 4

The apparatus of embodiment 3, wherein the upper and lower platens each include at least one vertical slot in a middle portion thereof.

### Embodiment 5

The apparatus of any one of the preceding embodiments, wherein the sample holder is mounting on a rotating pin such that it can be rotated 180° without removing it from apparatus. A locking mechanism can be used to lock the sample holder into place in the first position and in the second position for making the second notch.

### Embodiment 6

The apparatus of any one of the preceding embodiments, wherein the linear rail is connected to an attachment column that is mounted on the top surface.

### Embodiment 7

The apparatus of any one of the preceding embodiments, further comprising a safety guard placed so that the carriage assembly travels along a path between the linear rail and the safety guard.

### Embodiment 8

The apparatus of any one of the preceding embodiments, wherein the carriage assembly further comprises (iii) a handle extending out from a first side of the carriage for manually sliding the carriage along the linear rail.

### Embodiment 9

The apparatus of any one of the preceding embodiments, further comprising a locking pin that is moveable between (i) a locked position for holding the carriage assembly at a specified height and (ii) an unlocked position for allowing the carriage assembly to move along the linear rail.

### Embodiment 10

The apparatus of any one of the preceding embodiments, further comprising a stopper mounted on the top surface of the base to stop the sliding motion of the carriage assembly.

### Embodiment 11

The apparatus of any one of the preceding embodiments, wherein the blade holder comprises a spring loaded clamp.

### Embodiment 12

The apparatus of any one of the preceding embodiments, wherein the linear rail is inclined at an angle from about 95° to about 175°.

### Embodiment 13

The apparatus of any one of the preceding embodiments, wherein the carriage assembly is motorized.

### Embodiment 14

The apparatus of any one of the preceding embodiments, wherein the apparatus comprises one linear rail that is mounted upon the top surface.

### Embodiment 15

A method for making a notch in a material sample, the method comprising: securing the material sample in a sample holder of an apparatus for making notches (for example, as described in any one of the preceding embodiments), wherein the apparatus comprises: a base having a top surface; the sample holder mounted upon the top surface for placing the material sample; a linear rail that is mounted upon the top surface and inclined at an angle relative to the sample holder; and a carriage assembly attached to the linear rail. The carriage assembly can include a carriage capable of sliding along the linear rail; and a blade holder attached to the carriage; mounting a blade in the blade holder; and making a notch in the material sample by sliding the carriage assembly down the linear rail to push the blade through the material sample.

### Embodiment 16

The method of embodiment 14, further comprising using a stopper to control a depth of the notch.

### Embodiment 17

The method of any one of embodiments 14 to 16, further comprising retracting the carriage assembly up the linear rail until a locking pin locks the carriage assembly above a specified height.

### Embodiment 18

The method of any one of embodiments 14 to 17, further comprising: rotating the sample holder 180 degrees and remounting the sample holder to the top surface of the base; and making a second notch in the material sample by sliding the carriage assembly down the linear rail to push the blade through the material sample.

### Embodiment 19

The method of any one of embodiments 14 to 17, further comprising: rotating the sample holder 180 degrees without the sample holder from the apparatus; and making a second notch in the material sample by sliding the carriage assembly down the linear rail to push the blade through the material sample.

### Embodiment 20

The method of any one of embodiments 14 to 19, wherein the material sample is a polymeric film or sheet.

### Embodiment 21

The method of any one of embodiments 14 to 20, wherein the material sample comprises a thermoplastic polymer.

### Embodiment 22

The method of any one of embodiments 14 to 21, wherein a work of fracture toughness test results obtained from the notched material sample has a standard deviation of about 3.0 kJ/m² or lower.

### Embodiment 23

The method of any one of embodiments 14 to 22, wherein a regression analysis on work of fracture toughness test results obtained from the notched material sample have an R² of at least 0.80.

### Embodiment 24

An apparatus for making notches, comprising: a base having a top surface; a blade holder mounted upon the top surface for placing a blade; a linear rail that is mounted upon the top surface and inclined at an angle relative to the blade holder; and a carriage assembly attached to the linear rail. The carriage assembly includes a carriage capable of sliding along the linear rail; and a sample holder attached to the carriage. It is understood that any of the preceding embodiments can be applied to Embodiment 24 in the reverse, where the blade can be stationary mounted to the top surface and the sample holder can slide on the linear rail, where the sample holder can be rotated either by removing from the linear rail and rotating or by rotating 180° without removing from the linear rail.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An apparatus for making notches, comprising:
(a) a base having a top surface;
(b) a sample holder mounted upon the top surface for placing an associated sample;
(c) a linear rail that is mounted upon the top surface and inclined at an angle relative to the sample holder; and
(d) a carriage assembly attached to the linear rail, the carriage assembly including:
(i) a carriage capable of sliding along the linear rail; and
(ii) a blade holder attached to the carriage.

2. The apparatus of claim 1, wherein the sample holder is mounted upon the top surface through at least one positioning pin.

3. The apparatus of claim 1, wherein the sample holder comprises an upper platen and a lower platen, the associated sample being placed between the upper and lower platens.

4. The apparatus of claim 3, wherein the upper and lower platens each include at least one vertical slot in a middle portion thereof.

5. The apparatus of claim 1, wherein the linear rail is connected to an attachment column that is mounted on the top surface.

6. The apparatus of claim 1, further comprising a safety guard placed so that the carriage assembly travels along a path between the linear rail and the safety guard.

7. The apparatus of claim 1, wherein the carriage assembly further comprises (iii) a handle extending out from a first side of the carriage for manually sliding the carriage along the linear rail.

8. The apparatus of claim 1, further comprising a locking pin that is moveable between (i) a locked position for holding the carriage assembly at a specified height and (ii) an unlocked position for allowing the carriage assembly to move along the linear rail.

9. The apparatus of claim 1, further comprising a stopper mounted on the top surface of the base to stop the sliding motion of the carriage assembly.

10. The apparatus of claim 1, wherein the blade holder comprises a spring loaded clamp.

11. The apparatus of claim 1, wherein the linear rail is inclined at an angle from about 95° to about 175°.

12. The apparatus of claim 1, wherein the carriage assembly is motorized.

13. The apparatus of claim 1, wherein the apparatus comprises one linear rail that is mounted upon the top surface.

14. A method for making a notch in a material sample, the method comprising:
securing the material sample in a sample holder of an apparatus for making notches, wherein the apparatus comprises:
a base having a top surface;
the sample holder mounted upon the top surface for placing the material sample;
a linear rail that is mounted upon the top surface and inclined at an angle relative to the sample holder; and
a carriage assembly attached to the linear rail, the carriage assembly including:
(i) a carriage capable of sliding along the linear rail; and
(ii) a blade holder attached to the carriage;
mounting a blade in the blade holder; and
making a notch in the material sample by sliding the carriage assembly down the linear rail to push the blade through the material sample.

15. The method of claim 14, further comprising using a stopper to control a depth of the notch.

16. The method of claim 14, further comprising retracting the carriage assembly up the linear rail until a locking pin locks the carriage assembly above a specified height.

17. The method of claim 14, further comprising:
rotating the sample holder 180 degrees and remounting the sample holder to the top surface of the base; and
making a second notch in the material sample by sliding the carriage assembly down the linear rail to push the blade through the material sample.

18. The method of claim 14, wherein the material sample is a polymeric film or sheet.

19. The method of claim 14, wherein one or both of a work of fracture toughness test results obtained from the notched material sample has a standard deviation of about 3.0 kJ/m² or lower and a regression analysis on work of fracture toughness test results obtained from the notched material sample have an R² of at least 0.80.

20. An apparatus for making notches, comprising:
(e) a base having a top surface;
(f) a blade holder mounted upon the top surface for placing a blade;
(g) a linear rail that is mounted upon the top surface and inclined at an angle relative to the blade holder; and
(h) a carriage assembly attached to the linear rail, the carriage assembly including:
(iii) a carriage capable of sliding along the linear rail; and
(iv) a sample holder attached to the carriage.
